(19) United States
(12) Patent Application Publication
(10) Pub. No.: US 2003/0118005 A1
(43) Pub. Date: Jun. 26, 2003

(54) Secure top domain

(75) Inventors: Anna Ostberg, Upplands Vasby (SE); Erika Grunberger, Esolv (SE)

Correspondence Address: PILLSBURY WINTHROP, LLP, P.O. BOX 10500, MCLEAN, VA, 22102, US

(73) Assignee: F. a Anna Ostberg Design

(21) Appl. No.: 10/050,065

(22) Filed: Jan. 15, 2002

(30) Foreign Application Priority Data
Dec. 21, 2001 (SE) 0104364-5

(51) Int. Cl. H04L 9/00

(52) U.S. Cl. 370/352; 370/353

(57) ABSTRACT

The invention relates to an arrangement for blocking of unwanted network traffic in open data and telecommunication networks (10) and a method therefore. In order to provide a blocking of net-sites (390) that contradict ordre public two blocking levels (350, 400) exist through a top level domain with registration of sites (390) and with micro debitings

### TECHNICAL FIELD

The present invention pertains to a blocking arrangement for unwanted network traffic in open data and telecommunications networks such as Internet, and a method therefore.

### BACKGROUND ART

The Internet is by many regarded as a non structured marketplace, lacking an overall picture. Hereby it exists unwanted sites in the form of porno, terrorism, economic crime and others banned by law. Another problem is constituted by hackers and spreaders of computer viruses. In other words Internet, for example, is regarded as lacking a structure for serious or purged net traffic.

Current top level domains such as .com, .arpa, .edu, .net and others are putting up few barriers or non on sites regarding manners and customs (ordre public).

Homepages are expensive to establish and to maintain, which brings about that services through Internet are getting expensive. This phenomena has recently being brought to attention to the business, especially regarding trade sites in the Internet, which in many cases have turned bankrupt. Attempts to achieve direct incomes for made investments are accomplished through, e.g. banners, pop-ups, membership, password and others

All together there exists a great need of a reliable structure in www and the like so that users and service providers are able to feel comfortable in the use of www regarding matters of good manners and customs and how a yield for an arranged structure should be generated.

### SUMMARY OF THE DESCRIBED INVENTION

The present invention concerns a solution to the problem with unwanted net traffic in open networks for data and telecommunications, especially in the world wide web (www) through Internet or the like.

To provide a solution to problems mentioned, the present invention sets forth an arrangement for blocking of unwanted network traffic in open data and telecommunication networks. The arrangement hereby comprises:

a first level of blocking in the form of a top level domain requiring registration for web sites residing within the domain with respect to ordre public;

at least one top level domain server for connection to the top level domain comprising or being connected to a domain name server files or software, which assign a call, through a computer, a network address which associates to a correct application server when the user of the computer has been identified;

database means, connected to the top level domain server for registration and authorization of a services provider residing within the top level domain;

means connected to or comprised in the top level domain for identification of a calling parties identity during login to the top level domain;

means connected to or comprised in the top level domain server for blocking an unidentified calling party; and

whereby registration of those connected to the domain and the identification of a calling party prevents a free connection and anonymity in computer networks through said top level domain server, which accomplishes a top level domain purged from unwanted network traffic.

In one embodiment of the invention a second level of blocking is provided comprising micro debiting through a debiting server during connection to the top level domain, comprising the following means:

means for debiting of the top level domain via micro debiting;

means for accumulation of said micro debiting during every session a user is connected to said domain.

Another embodiment provides that the web address of the one connected is stored for debiting in a database.

A further embodiment provides means, through the debiting server, for percentage partitions in at least two posts of accumulated micro debitings for every session during login, which posts are credited to at least one of the top level domain and a registered service provider.

The present invention also provides a method relating to an arrangement for blocking of unwanted network traffic in open data and telecommunication networks. Hereby it comprises the method steps of:

providing a first level of blocking in the form of top level domain requiring registration for web sites residing within the domain with respect to ordre public;

connecting at least one top level domain server for connection to the top level domain comprising or being connected to a domain name server files or software, which assign a call, through a computer, a network address which associates to a correct application server when the user of computer has been identified;

connecting database means, connected to the top level domain server for registration and authorization of a services provider residing within the top level domain;

identifying a calling parties identity during login to the top level domain;

blocking through means for a such purpose of an unidentified calling party; and

whereby registration of those connected to the domain and the identification of a calling party prevents a free connection and anonymity in computer networks through said top level domain server, which accomplishes a top level domain purged from unwanted network traffic.

In one embodiment of the method according to the present invention it sets forth a second level of blocking comprising micro debiting through a debiting server during connection to the top level domain by:

means for debiting of the top level domain via micro debiting;

means for accumulation of said micro debiting during every session a user is connected to said domain.

The method according to the present invention is also enabled to constitute other embodiments for the blocking arrangement in accordance with the above.

### BRIEF DESCRIPTION OF THE DRAWINGS

Henceforth reference is had to the attached drawings in the continuing description text for a better understanding of given examples and embodiments of the present invention, whereby;

FIG. 1 is schematically illustrating a first level of blocking for the blocking arrangement according to the present invention in the form of a block diagram in an open network for data and telecommunication;

FIG. 2 is schematically illustrating a second level of blocking for the blocking arrangement in accordance with FIG. 1; and

FIG. 3 is schematically illustrating how a user is guided towards a top level domain according to the present invention.

### DETAILED DESCRIPTION OF PREFERRED EMBODIMENTS

In order to solve problems with unwanted web-based traffic and purging this from, e.g. child-porno, hackers, spreaders of viruses, economic crimes and others, the present invention provides a new top level domain, TLD. A new TLD as such does not provide anything remarkable, but if it is associated to specific terms for its use through for this matter foreseen means, it is able, in accordance with the present invention, to provide a solution to those problems earlier mentioned.

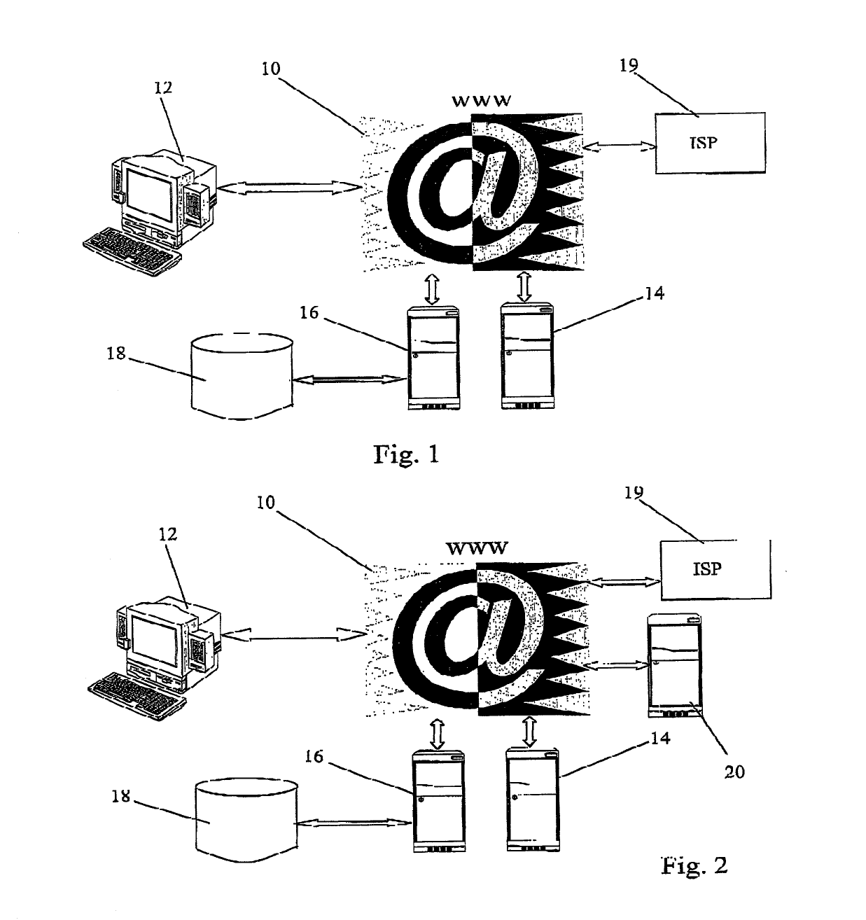

FIG. 1 schematically illustrates the blocking arrangement according to the present invention in the form a of block diagram in an open network for data and telecommunication. The invention provides two levels of blocking unwanted traffic in a network such as Internet or the like, whereby the levels are:

1. Blocking through registration of web-sites in the top level domain, whereby registered web-sites are approved after examination within stated criteria for the new TLD.

2. A login to the TLD is generating micro debitings.

In the present description, the level 2 is an embodiment of level 1. FIG. 1 is illustrating level 1 for blocking of unwanted web-sites, where double directed arrows constitute communication paths in www 10. FIG. 1 shows www 10 such as Internet, a computer 12 connected to www 10, a domain name server 14 (Domain Name Server, DNS), TLD server 16, a database 18 for registration of approved web-sites in the top level domain and a service provider 19 in Internet (Internet Service Provider). The server provide 19 thus has to be approved for registration in the TDL server 16 database 18 before services are allowed to be delivered in the top level domain in accordance with the present invention. This constitutes a level 1 blocking in the top level domain, correlated to that no TCP/TP addresses to users with a computer 12 which not can be identified are put through in the domain, but are blocked access and a possible registration in the database 18. The TLD server 16 in one embodiment comprises means to direct questions to connected computers 12 in order to identify those and their users.

A DNS 14 comprises programs and files that make up a DNS database where a net address, for example, xxx@yy.net is transferred to an IP address which associates to a correct application server.

To accomplish a block for unwanted web traffic, the present invention provides an arrangement for blocking of unwanted network traffic in open data and telecommunication networks. It comprises a first level of blocking in the form of a top level domain requiring registration for web sites residing within the domain with respect to ordre public. Further it comprises at least one top level domain server 16 for connection to the top level domain, comprising or being connected to a domain name server 14 files and software, which assign a call/connection, through computer 12, a network address which associates to a correct application server when the user of computer 12 has been identified. There exists database means 18, connected to the top level domain server 16 for registration and approval of a services provider 19 residing within the top level domain.

Further, it comprises means connected to or comprised in the top level domain server 16 for identification of a calling parties identity during login to the top level domain, And means connected to or comprised in the top level domain server 16 for blocking an unidentified calling party. Registration of those connected to the domain and the identification of a calling party prevents a free connection and anonymity in computer networks through said top level domain server 16, which accomplishes a top level domain purged from unwanted network traffic.

DNS software 14 and files that are comprised or connected to the top level domain server 16 could directly be used to produce IP address towards sites for approved identifiable users/logins to the top level domain.

In accordance with FIG. 2 a second security level for blocking of unwanted net traffic to the predetermined top level domain is schematically illustrated. In the figure a debiting server 20 (billing server) for micro debiting for login at the top level domain has been added, i.e. all user with computers 12 will be debited as soon as they are connected to the domain. This prevents uncalled net surfing.

The second level of blocking comprises micro debiting when connected to the top level domain through means for debiting the top level domain by the micro debiting, and means for accumulating micro debitings for every session a user is logged in to the domain. For micro debiting a plurality of known methods exist, for example, transmission of time based ticks. A connecting parties web address is then enabled for debiting in the database 18 and/or other database related to the debiting server 20.

The payment receiver is preferably the service provider 19 and an administrator of the new top level domain through means for percentage partition in at least two posts of accumulated micro debiting for every session during a login.

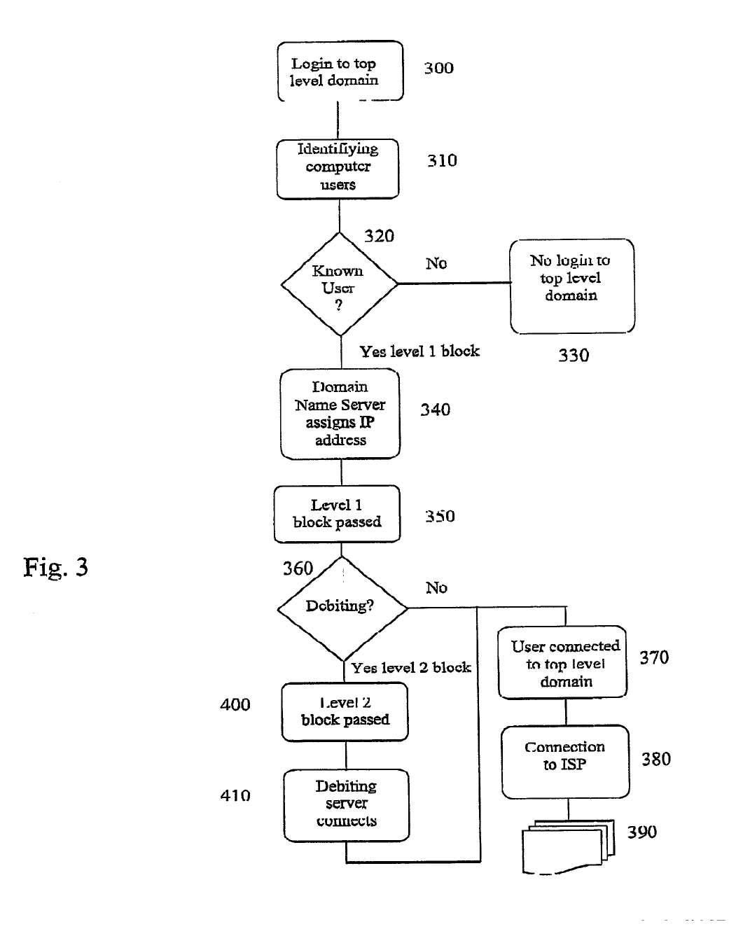

FIG. 3 schematically illustrates a flow chart of an embodiment of the present invention. A user/login with a computer 12 logging in 300 to the top level domain, whereby the means for blocking checks 310 if the login address and/or a user is known, which is conditioned 320. If the address and/or user are not identifiable no connection 330 to the top level domain is provided.

In the case of a connection to the top level domain a blocking level 1 is provided and the condition 320 is yes, then the DNS 14 assigns, or like software, the addressee that a login would like to reach, for example, www.zzz.net an IP address code 340. At the assigning of the IP address code blocking level 1 is passed, 350, whereby the searched site 390, through the ISP 380 in the top level domain, is connected to the computer 12 simultaneously as the level 1 block has been passed 380.

If a connection in accordance with level 2 is provided, it is conditioned 360, if a debiting should be provided or not. The conditioner 360 is physically seen a switch, which an administrator of the blocking arrangement is in control of in accordance with the present invention, whereby it by way of example can be turned on and off if specific times should bee free of debiting. At a yes condition level 2 block 400 is achieved and both a level 1 and level 2 block prevails. Passage of a level 2 block now triggers 410 a micro debiting towards the user, which is accumulated in, for example, the debiting server 20. If debiting is not accepted no connection to the top level domain 330 will be provided. After that the server 20 has been connected a connection can be provided through computer 12 to the top level domain 370 and connection to by way of example an ISP and further to a searched site 390.

Means described, within the technical field, in the present description are preferably made up of known software, hardware or a combination of both.

Although the present invention has been described by specific examples and embodiments, the wording of the attached claims suggest further embodiments to a person skilled in the art.

1. An arrangement for blocking of unwanted network traffic in open data and telecommunication networks, characterized by comprising:
a first level of blocking (350) in the form of a top level domain requiring registration for web sites (390) residing within the domain with respect to ordre public;
at least one top level domain server (16) for connection to the top level domain comprising or being connected to a domain name server (14) files and software, which assign a call, through computer (12), a network address (340) which associates to a correct application server (380) when the user of computer (12) has been identified;
database means (18), connected to the top level domain server (16) for registration and approval of a services provider (19) residing within the top level domain;
means connected to or comprised in the top level domain server (16) for identification of a calling parties identity (310) during login to the top level domain;
means connected to or comprised in the top level domain server (16) for blocking (330) an unidentified calling party; and
whereby registration of those connected to the domain and the identification of a calling party prevents a free connection and anonymity in computer networks through said top level domain server (16), which accomplishes a top level domain purged from unwanted network traffic.

2. An arrangement according to claim 1, characterized in that a second level of blocking (400) comprises micro debiting through a debiting server (20) during connection (410) to the top level domain by:
means for debiting of the top level domain via micro debiting;
means for accumulation of said micro debiting during every session a user is connected to said domain.

3. An arrangement according to claim 2, characterized in that the web address of the one connected (12) is stored for debiting in a database (18).

4. An arrangement according to claim 2 or 3, characterized by comprising:
means in the debiting server (20) for percentage partitions in at least two posts of accumulated micro debitings for every session during login, which posts are credited to at least one of the top level domain and a registered service provider.

5. A method relating to an arrangement for blocking of unwanted network traffic in open data and telecommunication networks, characterized by comprising, the method steps of:
providing a first level of blocking (350) in the form of a top level domain requiring registration for web sites (390) residing within the domain with respect to ordre public;
connecting at least one top level domain server (16) for connection to the top level domain comprising or being connected to a domain name server (14) files and software, which assign a call, through computer (12), a network address (340) which associates to a correct application server (380) when the user of computer (12) has been identified;
connecting database means (18), connected to the top level domain server (16) for registration and approval of a services provider (19) residing within the top level domain;
identifying a calling parties identity (320) during login to the top level domain;
blocking (330) through means for such a purpose of an unidentified calling party; and
whereby registration of those connected to the domain and the identification of a calling party prevents a free connection and anonymity in computer networks through said top level domain server (16), which accomplishes a top level domain purged from unwanted network traffic.

6. A method relating to an arrangement for blocking according to claim 5, characterized in that a second level of blocking (400) comprises micro debiting through a debiting server (20) during connection (410) to the top level domain by:
means for debiting of the top level domain via micro debiting;
means for accumulation of said micro debiting during every session a user is connected to said domain.

7. A method relating to an arrangement for blocking according to claim 6, characterized in that the web address of the one connected (12) in stored for debiting in a database (18).

8. A method relating to an arrangement for blocking according to claim 6 or 7, characterized by comprising means in the debiting server (20) for percentage partitions in at least two posts of accumulated micro debitings for every session during login, which posts are credited to at least one of the top level domain and a registered service provider.
